(19) United States
(12) Patent Application Publication
(10) Pub. No.: US 2011/0114246 A1
(43) Pub. Date: May 19, 2011

(54) APPLICATION OF SEALING MATERIALS TO SURFACES

(76) Inventor: Stephen Ainsworth, Coventry (GB)

(21) Appl. No.: 12/674,989

(22) PCT Filed: Sep. 23, 2008
(86) PCT No.: PCT/EP08/08014

§ 371 Date: Feb. 24, 2010

(30) Foreign Application Priority Data
Sep. 26, 2007 (GB) 0718788.3

(51) Int. Cl. B44C 1/17; G05G 15/00

(52) U.S. Cl. 156/64; 156/235; 156/538; 156/350; 156/378; 901/27

(57) ABSTRACT

A method and an apparatus for application of sealing or shim material to surfaces is provided. The materials are used in particular in the construction of aircraft and other vehicles. The materials are typically interposed in a joint between a vehicle structural element and a vehicle external surface forming component. The sealing materials are adherent. The apparatus of the invention includes a moveable arm carrying an end member having a curved surface. The arm applies the curves surface to a web of the sealing material so that the sealing material becomes wrapped around the curved surface. The arm is then moved to the location of the joint and the web of sealing or shim material is applied to the joint surface by causing or allowing the end member to roll of said surface.

### CROSS REFERENCE TO RELATED APPLICATIONS

This application is a U.S. National Phase application of International Application PCT/EP2008/008014 and claims the benefit of priority under 35 U.S.C. § 119 of Great Britain Patent Application GB 0718788.3 filed Sep. 26, 2007, the entire contents of which are incorporated herein by reference.

### FIELD OF THE INVENTION

The present invention relates to the application of sealing materials, such as polymeric sealing or shim materials to surfaces, for providing a seal between juxtaposed surfaces. The invention finds particular application in the aerospace and automotive industries. The invention relates especially to the uniting of metal surfaces to fibre reinforced materials such as carbon-fibre substrates using a sealing material.

### BACKGROUND OF THE INVENTION

In the aerospace industry, the joining of composite materials such as fiber reinforced materials (e.g. fibre reinforced composites such as carbon fibre reinforced plastic (CFRP) materials) to a metal surface is a common requirement. For example, in the manufacture of an aircraft, it is necessary to apply carbon fibre based exterior components to an underlying metal frame (the airframe). Joints of this type are known as interfay joints. The seal between the components must meet numerous onerous requirements necessary to meet the challenges of the working environment of the aircraft. For example, the seal must be electrically insulating and must prevent penetration of water or other liquids such as fuel and must be able to withstand a wide range of temperatures over the whole operating life of the aircraft. The sealing material must also be chemically compatible with materials used locally to the seal in the aircraft manufacture, such as metals and coatings.

In one prior art method, a liquid seal or “shim” is used. In the context of aircraft manufacture, carbon fibre based substrates are prepared by a molding technique. The face of the substrate which was in contact with the mold surface has desirable smoothness, suitable, for example, for forming the external surface of the aircraft. The opposite face of the substrate is less smooth and must be smoothed or levelled. The liquid shim is used for this purpose. In one prior art process, the inner surface of the carbon fibre based substrate is covered with an inhibitor for the liquid shim. The liquid shim itself is then applied to the metal surface after which the carbon fibre substrate and the metal surface are brought together. A time of several hours is then commonly required in order for the sealing liquid shim to cure. When curing is complete, the carbon fibre substrate and the metal surface are separated, the inhibitor is removed from the carbon fibre substrate and the two components are once again brought together so forming a joint between them. This process has numerous drawbacks, not least of which is the overall time taken. Also, there are commonly difficulties in achieving an exact location of the carbon fibre panel on the metal surface at the second stage, after removal of the inhibitor. This can compromise the integrity of the joint and can cause difficulties arising from misalignment of bolt holes formed in the substrate and the metal frame, for example.

In order to address the deficiencies of the above process, techniques have been developed in which the sealing material (shim) is at least partially cured in a preliminary stage and is formed into a sheet or web prior to application to the respective surfaces of the carbon fibre substrate and the metal frame component. Reinforcing materials can also be incorporated into the web or sheet of sealant. In effect, the sealant or shim becomes a sort of gasket. A further advantage is that whereas a liquid sealant may be expelled from a joint when the joint is placed in compression, this cannot occur with the reinforced web material. The process of using a seal made from an at least partially cured web or sheet of sealant is described in EP 1 548 083. In both the liquid shim technique and in the technique described in EP 1 548083 using an at least partially cured web, the sealant is formed from a polysulfide material.

EP 1 548083 and more especially EP 1 548337 address a further problem, which is to achieve the correct depth or thickness of sealant for the joint being formed. Typically joint spacings within which the sealant must lie are less than 1.5 mm and may commonly be less than 1 mm. However, greater thicknesses may on occasion be required. In the case of the liquid shim technique, considerable skill is required by an operator to achieve the correct thickness. EP 1 548 337 addresses this issue by determining the required thickness of the sealant and providing a web of sealant of a composition and/or appropriate thickness. Composition of the sealant can be relevant in as much as it can affect the maximum degree of compression (Le. minimum thickness) of the sealant in the joint. In practice, the cured or partially cured sealant web may be available in various grades, each grade differing in thickness by, for example, 0.4 mm from the next grade. Factors to be considered in choosing an appropriate thickness of sealing material include the minimum thickness of the material under compression and the maximum spacing between the components to be joined. Variations in the required thickness of sealant can occur because of, for example, variations in the thickness of the CFRP material.

The techniques of providing seals and forming joints described in EP 1 548 083 and EP 1 548337 provide significant benefits over earlier prior art techniques, but some disadvantages remain. In particular, the application of the sealing material remains labor intensive and in the case, for example, of the application of the sealing material to parts of a large structure, such as an aircraft wing, may require operators fitting the sealing material to be in an environment which presents significant health and safety risks. In other applications, the sealing material may need to be applied in confined or inaccessible locations. The present invention seeks to alleviate or obviate some of these difficulties.

### SUMMARY OF THE INVENTION

In accordance with a first aspect of the present invention there is provided a method of applying a web of adherent sealing material to a component surface, the method comprising:
(I) providing a moveable arm having an end member defining a curved external surface;
(ii) moving said arm to apply said curved surface to a first exposed surface of said web thereby to adhere said web to said curved external surface;
(iii) moving said arm to bring an exposed second surface of the sealing material into contact with the component surface along an initial line of contact; and
(iv) causing said end member to rotate thereby to move said initial line of contact over the component surface so adhering the sealing material to the component surface and to releasing the sealing material from the curved external surface of the end member.

In one preferred embodiment said arm is configured so that the end member applies pressure to the sealing material during said rotating step.

In another preferred embodiment said curved external surface of said end member is substantially cylindrical or part cylindrical.

Preferably said end member is a roller.

In preferred embodiments said rotating step comprises moving said roller over the component surface, thereby causing the roller to rotate.

Preferably said moveable arm is an automatically operable robotic arm.

Preferably said component is a vehicle component.

In particularly preferred embodiments said component is a structural vehicle component.

Preferably said vehicle is an aircraft.

In especially preferred embodiments said component is a part of an aircraft airframe.

Preferably said component is a metal or metal alloy component.

In other preferred embodiments the method of this aspect of the invention further comprises
a. determining a maximum spacing between said component surface and an opposed surface of a further component when said components are joined;
b. providing a plurality of webs of adherent sealing material each of a different predetermined thickness and/or composition; and
c. selecting a web of appropriate thickness and/or composition from said plurality of webs in accordance with said determined maximum spacing and, in step (ii), moving said arm to apply said curved surface to a first exposed surface of said selected web thereby to adhere said selected web to said curved external surface.

In preferred variations of the above embodiments the step of determining said maximum spacing includes measuring the thickness of said further component.

Preferably the second surface of the web of adherent sealing material is covered by a release paper, membrane, film or the like the method further comprising exposing said second surface by removing said release paper, membrane, film or the like prior to bringing said second surface into contact with the component surface.

In further preferred embodiments said component surface is one of a plurality of spaced apart component surfaces, the method further comprising repeating steps (ii) to (iv) to apply a web of sealing material to at least a further one of said plurality of spaced apart component surfaces.

Preferably the method further comprises the step of determining the position of at least a further one of said plurality of spaced apart component surfaces and, in accordance with step (iii), moving said arm to bring a second exposed surface of the sealing material into contact with the further component surface along a line of contact in accordance with the determined position of the further component.

Preferably the adherent web of sealing material is formed from a cured or partially cured polysulfide sealant material.

According to a second aspect of the present invention there is provided apparatus for applying a web of adherent sealing material to a component surface, the apparatus comprising:
a moveable arm having an end member defining a curved external surface;
means operable to move said arm to a first position in which said curved surface can be applied to a first exposed surface of said web of sealing material and means operable to apply said curved external surface to said first exposed surface such that said web becomes adhered to said curved external surface;
means operable to move said arm to a second position proximate said component surface and to bring a second exposed surface of the sealing material into contact with the component surface along a line of contact; and
means operable to rotate said end member to move said line of contact over the component surface thereby to adhere the sealing material to the component surface and to release the sealing material from the curved external surface of the end member.

Preferably the end member is operable to apply pressure to the sealing material during the rotation of said end member.

In particularly preferred embodiments said curved external surface of said end member is substantially cylindrical or part cylindrical.

Preferably said end member is a roller.

Preferably the apparatus of this aspect of the invention comprises means operable to move said roller over the component surface, thereby causing the roller to rotate.

Preferably said moveable arm is an automatically operable robotic arm.

In further preferred embodiments, the apparatus of this aspect of the invention comprises:

means operable to determine a maximum spacing between said component surface and an opposed surface of a further component when said components are joined and;
means operable to select, in accordance with said determined maximum spacing, a web of appropriate thickness and/or composition from a plurality of webs of a different predetermined thicknesses and/or compositions; and
means operable to move said arm to apply said curved surface to a first exposed surface of said selected web thereby to adhere said selected web to said curved external surface.

Preferably the second surface of the web of adherent sealing material is covered by a release paper, membrane, film or the like, the apparatus further comprising means operable remove said release paper, membrane, film or the like thereby to expose said second surface.

Preferably said component surface is one of a plurality of spaced apart component surfaces, the apparatus further comprising means operable to select at least a further one of said spaced apart component surfaces for application of a web of sealing material.

According to a third aspect of the invention there is provided an assembly comprising an apparatus and a vehicle under construction, the vehicle including at least one said component surface.

Preferably in this aspect said component is a structural vehicle component.

Preferably said vehicle is an aircraft.

It is particularly preferred that said component is a part of an aircraft airframe.

Preferably the adherent web of sealing material is formed from a cured or partially cured polysulfide sealant.

The invention is primarily described herein in the context of application of sealing materials to surfaces to be joined in the construction of an aircraft. It will be appreciated, however, that the invention is not confined to aircraft construction and may usefully be applied in the automotive industry for the construction of cars, trucks and the like.

For a better understanding of the invention and to show how the same may be carried into effect, reference will be made, by way of example only to the following drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic representation of a device or apparatus for dispensing sealing material for use in the present invention;

FIG. 2 is a schematic representation of a moveable arm and its associated curved surface according to the invention;

FIG. 3 is a schematic representation of the a roller of the apparatus of the invention carrying a web of sealing material;

FIG. 4 is a schematic representation of the application of a web of sealing material to a vehicle component in accordance with the present invention; and

FIG. 5 is a schematic representation of an alternative configuration of an end member of the moveable arm of the apparatus.

### DESCRIPTION OF THE PREFERRED EMBODIMENTS

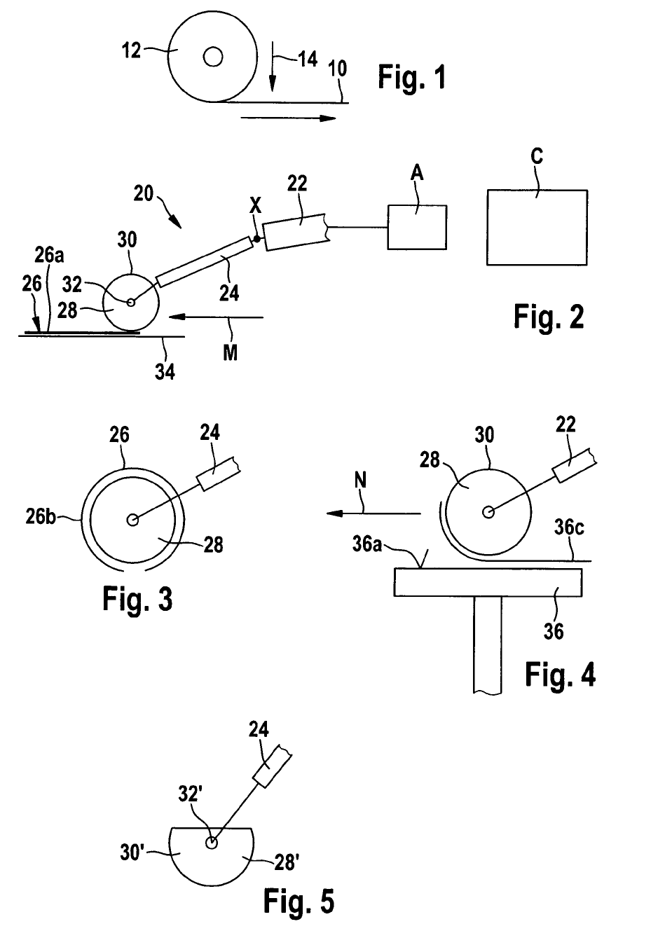

Referring to the drawings in particular, FIG. 1 shows a stock of sealing or shim material 10 carried on a dispensing roll 12. The width of the sealing material 10 on the roll corresponds to one dimension of the surface to which the sealing material is to be applied. The roll 12 is advanced by an appropriate distance and a cutter 14 (shown schematically as an arrow) is used to cut the sealing material into a web of a desired length. The cutter 14 may be a mechanical cutter or a laser cutter, for example. The desired length corresponds to the other dimension of the surface to which the sealing material is to be applied. Thus the length and width of the web of sealing material are usually (but not essentially) selected to correspond to the length and width of the surface to which the sealing material is to be applied.

In some cases, the surface to which the web of sealing material is to be applied, or the portion of the surface to which the web of sealing material is to be applied is not a regular square or rectangle in shape. In such cases, it may not be appropriate to supply the stock of sealing or shim material as a roll. The web material may be received from a supplier (or an earlier manufacturing stage) in a flat condition and may be supplied precut to the desired shape for the surface to which it is to be applied. Alternatively, the web of sealing or shim material may require cutting to shape. In the latter case, the present invention includes the step of cutting the web of sealing or shim material to the desired shape. Preferably, the method of the present invention includes use of a laser cutting apparatus to form the web of material into the desired (irregular) shape.

In one particularly preferred application of the invention, the surface to which the web of sealing material is to be applied is the surface of a rib foot in an aircraft wing structure. In the structure of an aircraft wing, structural ribs are arranged generally longitudinally (with respect to the aircraft) and intersect with stringers which are arranged generally laterally. The ribs are indented to accommodate the stringers. Thus the ribs have a plurality of foot portions which are isolated from one another, each foot portion having an outer surface to which the wing skin (Le wing external surface) is attached. The wing skin is typically made from CFRP or like materials. The wing skin may be bolted to the rib feet and the sealing material or shim is interposed between the rib feet and the internal surface of the wing skin Thus, the sealing material is applied in the form of discrete web sections which are normally sized to correspond to the size of the rib feet.

The apparatus of the invention is used for collecting a web of sealing or shim material, transferring the sealing material to the location of a selected rib foot and applying the sealing material to the rib foot. The apparatus may also include means for determining a required thickness of sealing or shim material and selecting the sealing material of appropriate thickness from a plurality of available materials (e.g. a plurality of rolls 12 carrying sealing materials of different thicknesses).

In one preferred form, shown schematically in FIG. 2 the apparatus 20 comprises an arm 22 which includes a compliant section 24. The compliant section 24 may, for example, be extensible and biased towards a selected maximum length and/or may be mounted for rotation about a nominally horizontal axis X (axis X is nominally horizontal with respect to the arrangement and configuration shown in FIG. 2) so that the compliant section can execute an up and down movement. In the is case, the compliant section may, in use, usefully be biased downwardly, with a view to applying, when desired, a suitable pressure to the web of sealing material 26. The arm 22 and its compliant section 24 are operated by suitable actuators shown schematically at A. Suitable actuators are known in the art and may include one or more of hydraulic actuators, pneumatic actuators and actuators driven by electric motors. The arm 22 and actuators A are controlled in use by a control means C which is suitably a computerized control means, as known in the art.

Arm 22 terminates in an end member 28 defining a curved external surface 30. In the embodiment shown in FIG. 2, the curved external surface 30 is cylindrical and the end member 28 takes the form of a roller. An alternative configuration of the end member is shown in FIG. 5. In FIG. 5, end member 28′ defines a part cylindrical external surface 30′. In preferred configurations, the end member 28, 28′ rotates in use about an axis 32, 32′. Rotation may be passive (Le. the end member is mounted so that it is substantially freely rotatable) or active (Le. the rotation is driven by suitable driving means (not shown) under the control of control means C).

In the method of the invention, surface 30, 30′ of end member 28,28′ is brought into contact with an exposed first surface 26a of the web 26 of sealing material. The web 26 is supported on a suitable supporting surface 34. In preferred applications the sealing or shim material is formed from a polysulfide material which is wholly or partially cured. Where the polysulfide material is partially cured, the degree of curing is sufficient for the sealant or shim to be in the form of a coherent web of material. The polysulfide shim or sealant is inherently adherent—in other words it is sufficiently tacky or sticky to enable it temporarily to adhere to the end member 28.

The end member 28,28′ is brought into contact with an exposed first surface 26a of the web 26 of sealing material, initially close to a marginal edge of the web 26. A line of contact along a radius of the end member is established between the end member 28, 28′ and the web 26. The end member 28, 28′ is then moved (in the direction indicated by arrow M in FIG. 2). The end member 28, 28′ rotates and the web 26 thus becomes adhered to the end member 28, 28′, as illustrated in FIG. 3.

In this configuration, the web of sealing or shim material is carried by the end member 28,28′ and its second surface 26b becomes exposed. The second surface 26b may initially be covered with a release paper or the like which is removed before the steps described below. Removal of the release paper is preferably automated and may be carried out by any suitable known method or apparatus.

With the web 26 of sealing or shim material carried on the end member 28, 28′, the arm 22 is moved under the control of control unit C so that the end member 28, 28′ is brought into proximity with a rib foot. Rib foot 36 has an upper surface 36a to which the web 26 of shim or sealing material is to be applied. Arm 22 aligns end member 28,28′ with the rib foot surface 36a so that an edge of the web 26 is arranged at an edge 36e of the rib foot (or other predetermined location of the rib foot 36). The second exposed surface 26b of the web 30 is then brought into contact with the surface 36a of rib foot 36 along an initial line of contact. The initial line of contact corresponds to a radius of the end member 28, 28′. The end member 28, 28′ is then advanced in the direction of arrow N so that the line of contact advances also over the surface 36a of the rib foot 36. The arm 22 and compliant section 24 are usefully configured to apply pressure to the web of sealing or shim material 26 as the web is applied to surface 36a. The web of material 26 is thus progressively transferred from the end member 28, 28′ onto the surface 36a. As will be apparent, as the end member 28,28′ is advanced, it rotates so that the second exposed surface of the web is progressively brought into contact with surface 36a of rib foot 36. It is of course desirable for the application of the web of sealing or shim material to the rib foot surface that the degree of adhesion of the web 26 to the rib foot surface is greater than its degree of adhesion to the curved surface 30, 30′ of the end member 28, 28′. The surface of the rib foot may be suitably treated to promote adhesion of the web of shim or sealing material and the surface 30, 30′ may be treated to achieve only a minimum desired adhesion.

After application of the web 26 to the rib foot 36, the arm 22 may be controlled to collect a further web 26 for application to a further rib foot 36.

The apparatus of the invention may also include means for determining a required thickness of the sealing or shim material and for selecting a material of the determined thickness. When components to be joined are brought together for assembly into, for example, a vehicle such as an aircraft, there is a spacing or gap between the components which the sealing or shim material is intended to fill. For various reasons including, for example, manufacturing tolerances, the size of the gap may vary from joint to joint. In the case of the application of a wing skin to a wing rib foot, such variations in the gap size caused by manufacturing tolerances or the like must be accommodated in the joint in order not to compromise the external profile of the wing skin Distortion of the wing skin out of its desired profile has disadvantageous aerodynamic consequences for the aircraft. Thus the apparatus of the invention is desirably provided with means for determining the size of the gap between the rib foot and the internal face of the wing skin and for selecting a web of sealing or shim material appropriate to that gap size. In one preferred embodiment the apparatus of the invention is provided with means for measuring the local thickness of a component to be joined (in particular a wing skin) in the area of the intended joint and using this measured thickness to determine the size of the gap between the components to be joined (e.g. the wing skin and the rib foot). For example, the apparatus of the invention may be provided with ultrasonic means for measuring the local thickness. Ultrasonic devices for measuring thickness are known as such. The apparatus may also desirably include means for determining the exact special location of the other component to be joined (e.g. the surface of the rib foot) which may also be subject to variation due to manufacturing tolerances or the like. The absolute or relative special location of the surface of the rib foot is also then used in the calculation of the required thickness of the web of sealing or shim material for a given joint.

In preferred configurations of the invention, a plurality of webs of sealing or shim material is provided each of a different thickness. Each thickness web may be carried on a separate roll 12. In the method of the invention, the desired thickness of the web 26 of sealing or shim material is determined and the arm 22 is controlled by control arrangement C to pick up a web 26 of desired thickness from the stock of webs of different thickness. The webs 26 may, for example, be made available in 0.4 mm steps between a given web and an adjacent web in the thickness range.

A particular advantage of the present invention lies in the application of webs of sealing or shim material in the construction of aircraft wings. Aircraft wings, especially for commercial aircraft are very large structures, commonly several tens of meters in length and several meters in width. Conventional wing assembly therefore requires operatives to work at potentially dangerous heights above ground level and in locations where secure stepping points are difficult to provide. This has obviously safety implications for assembly personnel. By means of the present invention, the process of application of the web of sealing or shim material to the wing rib feet is automated so that personnel are no longer required to work in a dangerous environment. It is also of course true that automation of the process of application of the webs of shim or sealing material also facilitates the application of such webs in confined locations, such as may occur on or in different types of vehicle, where access by personnel is also difficult.

Throughout the description and claims of this specification, the words “comprise” and “contain” and variations of the words, for example “comprising” and “comprises”, means “including but not limited to”, and is not intended to (and does not) exclude other moieties. additives. components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

While specific embodiments of the invention have been described in detail to illustrate the application of the principles of the invention, it will be understood that the invention may be embodied otherwise without departing from such principles.

1. A method of applying a web of adherent sealing material to a component surface, the method comprising the steps of:
(i) providing a moveable arm having an end member defining a curved external surface;
(ii) moving said arm to apply said curved surface to a first exposed surface of said web thereby to adhere said web to said curved external surface;
(iii) moving said arm to bring an exposed second surface of the sealing material into contact with the component surface along an initial line of contact; and
(iv) causing said end member to rotate and moving said initial line of contact over the component surface for adhering the sealing material to the component surface and releasing the sealing material from the curved external surface of the end member.

2. A method as claimed in claim 1, wherein said arm is configured so that the end member applies pressure to the sealing material during said step of causing said end member to rotate.

3. A method as claimed in claim 1, wherein said curved external surface of said end member is substantially cylindrical or part cylindrical.

4. A method as claimed in claim 1, wherein said end member is a roller.

5. A method as claimed in claim 4, wherein said step of causing said end member to rotate comprises moving said roller over the component surface, thereby causing the roller to rotate.

6. A method as claimed in claim 1, wherein said moveable arm is an automatically operable robotic arm.

7. A method as claimed in claim 1, wherein said component is a vehicle component.

8. A method as claimed in claim 7, wherein said component is a structural vehicle component.

9. A method as claimed in claim 8, wherein said vehicle is an aircraft.

10. A method as claimed in claim 9, wherein said component is a part of an aircraft airframe.

11. A method as claimed in claim 1, wherein said component is a metal or metal alloy component.

12. A method as claimed in claim 1, further comprising the steps of:
a. determining a maximum spacing between said component surface and an opposed surface of a further component when said components are joined;
b. providing a plurality of webs of adherent sealing material each of a different predetermined thickness and/or composition; and
c. selecting a web of appropriate thickness and/or composition from said plurality of webs in accordance with said determined maximum spacing and, in step (ii), moving said arm to apply said curved surface to a first exposed surface of said selected web thereby to adhere said selected web to said curved external surface.

13. A method as claimed in claim 12, wherein the step of determining said maximum spacing includes measuring the thickness of said further component.

14. A method as claimed in claim 1, wherein the second surface of the web of adherent sealing material is covered by a release paper, membrane, film or layer, the method further comprising exposing said second surface by removing said release paper, membrane, film or layer prior to bringing said second surface into contact with the component surface.

15. A method as claimed in claim 1, wherein said component surface is one of a plurality of spaced apart component surfaces, the method further comprising repeating steps ii to v to apply a web of sealing material to at least a further one of said plurality of spaced apart component surfaces.

16. A method as claimed in claim 15, further comprising the step of:
determining the position of at least a further one of said plurality of spaced apart component surfaces and;
in accordance with step (iii), moving said arm to bring a second exposed surface of the sealing material into contact with the further component surface along a line of contact in accordance with the determined position of the further component.

17. A method as claimed in claim 1, wherein the adherent web of sealing material is formed from a cured or partially cured polysulfide sealant material.

18. An apparatus for applying a web of adherent sealing material to a component surface, the apparatus comprising:
a moveable arm having an end member defining a curved external surface;
means operable to move said arm to a first position in which said curved surface can be applied to a first exposed surface of said web of sealing material; and
means operable to apply said curved external surface to said first exposed surface such that said web becomes adhered to said curved external surface;
means operable to move said arm to a second position proximate said component surface and to bring a second exposed surface of the sealing material into contact with the component surface along a line of contact; and
means operable to rotate said end member to move said line of contact over the component surface thereby to adhere the sealing material to the component surface and to release the sealing material from the curved external surface of the end member.

19. An apparatus as claimed in claim 18, wherein the end member is operable to apply pressure to the sealing material during the rotation of said end member.

20. An apparatus as claimed in claim 18, wherein said the curved external surface of said end member is substantially cylindrical or part cylindrical.

21. An apparatus as claimed in claim 18, wherein said end member is a roller.

22. An apparatus as claimed in claim 21, further comprising means operable to move said roller over the component surface, thereby causing the roller to rotate.

23. An apparatus as claimed in claim 18, wherein said moveable arm is an automatically operable robotic arm.

24. An apparatus as claimed in claim 18, further comprising:
means operable to determine a maximum spacing between said component surface and an opposed surface of a further component when said components are joined;
means operable to select, in accordance with said determined maximum spacing, a web of appropriate thickness and/or composition from a plurality of webs of a different predetermined thicknesses and/or compositions; and
means operable to move said arm to apply said curved surface to a first exposed surface of said selected web thereby to adhere said selected web to said curved external surface.

25. An apparatus as claimed in claim 18, wherein the second surface of the web of adherent sealing material is covered by a release paper, membrane, film or layer, the apparatus further comprising means operable remove said release paper, membrane, film or layer thereby to expose said second surface.

26. An apparatus as claimed in claim 18, wherein said component surface is one of a plurality of spaced apart component surfaces, the apparatus further comprising means operable to select at least a further one of said spaced apart component surfaces for application of a web of sealing material.

27. An assembly comprising;
an apparatus comprising a moveable arm having an end member defining a curved external surface, means operable to move said arm to a first position in which said curved surface can be applied to a first exposed surface of said web of sealing material, means operable to apply said curved external surface to said first exposed surface such that said web becomes adhered to said curved external surface, means operable to move said arm to a second position proximate said component surface and to bring a second exposed surface of the sealing material into contact with the component surface along a line of contact and means operable to rotate said end member to move said line of contact over the component surface thereby to adhere the sealing material to the component surface and to release the sealing material from the curved external surface of the end member; and
a vehicle under construction, the vehicle including at least one said component surface.

28. An assembly as claimed in claim 27, wherein said component is a structural vehicle component.

29. An assembly as claimed in claim 27, wherein said vehicle is an aircraft.

30. An assembly as claimed in claim 29, wherein said component is a part of an aircraft airframe.

31. An assembly as claimed in claim 27, wherein the adherent web of sealing material is formed from a cured or partially cured polysulfide sealant.

32. (canceled)

33. (canceled)
